(19) United States
(12) Patent Application Publication
(10) Pub. No.: US 2005/0101703 A1
(43) Pub. Date: May 12, 2005

(54) Method for the production of optically brightened polyester

(76) Inventors: Thomas Martini, Kelkheim-Fischbach (DE); Alexander Lerch, Gelnhausen (DE); Gerhard Zirkenbach, Rudesheim (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/471,951

(22) PCT Filed: Mar. 16, 2002
(86) PCT No.: PCT/EP02/02956

(30) Foreign Application Priority Data
Mar. 23, 2001 (DE) 101146965

(51) Int. Cl. C08K 5/34; C08K 5/48

(52) U.S. Cl. 524/94; 524/95; 524/99

(57) ABSTRACT

In the production of polyester from a polyol, preferably di-alcohol, and a polycarboxylic acid, preferably dicarboxylic acid, an optical brightener is added in the esterification process whose structure is free from open-chain ethylenic double bonds and as a result is chemically stable to the free acid used.

A number of processes are known for producing polyester, for example synthesis based on dimethyl terephthalate (DMT) and ethylene glycol. In this case, methanol is first distilled off in a transesterification reaction with an excess of ethylene glycol and then the glycol excess is reduced and condensed under reduced pressure. In a further important process the polymer may be prepared by reaction of free terephthalic acid (TPA) and ethylene glycol. In this case the terephthalic acid is first esterified with an excess of ethylene glycol under pressure at approximately 260° C. and this excess is then removed under reduced pressure and the reaction mixture is condensed. Recycled material processes are also known for producing polyester material. Fields of application which are large in terms of volume for polyester are producing polyester fibers and use as a food container, for example in the form of bottles and in the form of films of all type.

Optical brighteners, depending on their chemical stability, are added at differing time points to the polymer for producing brightened polyester. The great majority of fiber manufacturers therefore add the optical brightener as an active substance to the polycondensation stage or as a masterbatch to the polyester material. The addition of optical brighteners to the transesterification phase is also known. The use of optical brighteners which can be added as early as the esterification phase without decomposition is generally unknown. These thermally stable and acid-stable optical brighteners firstly increase the reproducibility of the product properties and the ability to plan them, and secondly these are considerably easier to apply industrially, since complex lock systems for application of the active compound afterward are avoided. In particular, recycled material processes profit from thermally stable and acid-stable optical brighteners.

Technically important optical brighteners for polyester have the basic structure 2,2′-(1,2-ethylenediyl-4,1-phenylene)bisbenzoxazole, which can be substituted in different ways. Thus it is possible to use these optical brighteners in the form of a dispersion in glycol in the production of polyester at the stage of the transesterification of DMT with glycol.

However, in the direct esterification of PTA with glycol, it is not possible to use this class of product, since, in the presence of acids due to chemical decomposition, its activity is considerably limited. This class of brightener can thus be applied only after virtually complete or complete esterification. It has now surprisingly been found that this problem may be solved by using those optical brighteners whose structure is free from one or more open-chain ethylenic double bonds.

The invention relates to a process for producing optically brightened polyester by esterifying an aliphatic and/or aromatic polycarboxylic acid, preferably dicarboxylic acid, and a polyol, preferably diol, characterized in that the esterification is carried out in the presence of an optical brightener whose structure is free from one or more open-chain ethylenic double bonds.

Suitable compounds for producing the polyester are all dicarboxylic acids and dihydric or polyhydric alcohols, as are customarily used in the production of polyesters, for example terephthalic acid, iosphthalic acid, 5-sulfoisophthalic acid, naphthalenedicarboxylic acid and ethylene glycol, propylene glycol, 1,2-butylene glycol, 1,4-butylene glycol, glycerol, pentaerythritol. A preferred polyester is polyethylene terephthalate (PET).

Optical brighteners which can be used are those products whose structure is free from one or more open-chain ethylenic double bonds. Preferred optical brighteners are compounds of the formulae 1 to 4 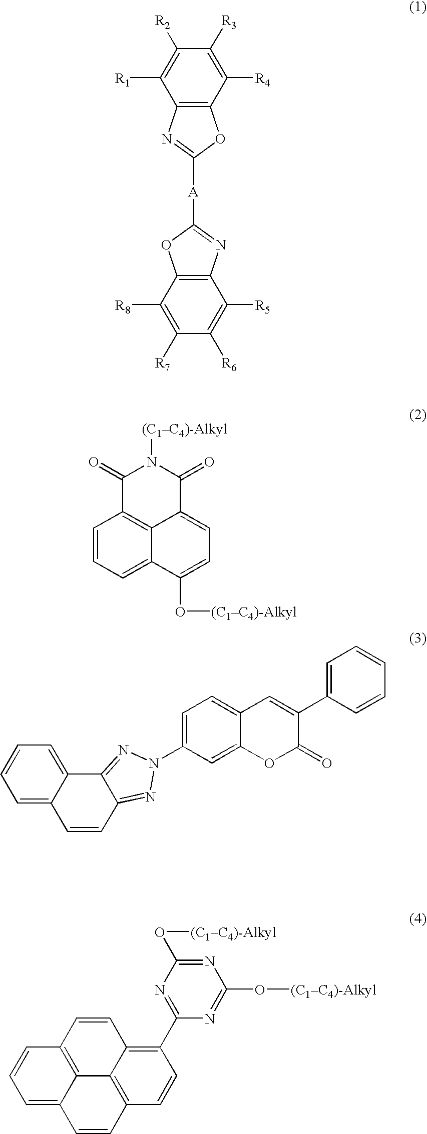
where

R₁ to R₈ independently of one another are hydrogen, C₁-C₂₀-alkyl or groups of the formula —COOR₉, where R₉ is hydrogen, C₁-C₂₀-alkyl or phenyl, or R₁ to R₈ are a group of the formula —SO₂R₁₀, where R₁₀ is hydrogen, C₁-C₁₀-alkyl or C₁-C₁₀-hydroxyalkyl, and

A is naphthylene, phenylene, thiophenylene or biphenylene.

The optical brighteners are fed to the synthesis before the esterification. This is then followed by esterification and condensation according to the processes known and customary in the production of polyester: in the same manner these optical brighteners may also be used in recycled material processes for recycling PET, where, preferably, the optical brightener is added to the glycol.

### EXAMPLES

0.25 g (500 ppm) of the optical brightener were heated in 450 g of glycol and 50 g of terephthalic acid under inert gas atmosphere at 260° C. for 1 hour and 5 hours and held at this temperature. After samples were taken, the chemical breakdown of the structures was determined by HPLC (additive) and UV (polymerizable brightener). Both methods are calibrated against standards.

Examples of optical brighteners without olefinic double bonds (according to the invention)

| | | | | Breakdown | Breakdown | Analytical |
|---|---|---|---|---|---|---|
| Brightener | Diol | Temperature | Pressure | after 1 h | after 5 h | Method |
| 4-Methoxy-N-methyl-1,8- | Triglycol | 260° C. | LP | <10% | >25% | HPLC |
| naphthalimide | | | | | | |
| 1,4-Bis((5-tert-butyl)-2- | Triglycol | 260° C. | LP | <10% | Approx. | HPLC |
| benzoxazolyl)thiophene | | | | | 20% | |
| 3-Phenyl-7-(1,2-2H- | Triglycol | 260° C. | LP | Approx. | 40% | HPLC |
| naphothtriazolyl) | | | | 30% | | |
| coumarin | | | | | | |
| Hostalux KCB: 1,4-Bis- | Triglycol | 260° C. | LP | <1% | <1% | HPLC |
| (2-benzoxazolyl)- | | | | | | |
| naphthalene | | | | | | |
| 4,4′-Bisbenzoxazolyl-1,1- | Triglycol | 260° C. | LP | <1% | <1% | HPLC |
| biphenyl | | | | | | |
| 1,4-Bis((5- | Triglycol | 260° C. | LP | <1% | <1% | UV/Vis |
| carboxymethyl)-2- | | | | | | (Biester) |
| benzoxazolyl)napthalene | | | | | | |
| Hostlux SE: 1,4-Bis((5- | Ethylene | 260° C. | 4 bar | <1% | <1% | UV VIS |
| carboxymethyl)-2- | glycol | | | | | |
| benzoxazolyl)- | | | | | | |
| naphthalene | | | | | | |
| 1,4-Bis((5-carboxy)-2- | Ethylene | 260° C. | 4 bar | <1% | <1% | UV VIS |
| benzoxyzolyl)- | glycol | | | | | |
| naphthalene | | | | | | |

Examples of optical brighteners containing olefinic double bonds

| | | | | Breakdown | Breakdown | Analytical |
|---|---|---|---|---|---|---|
| Brightener | Diol | Temperature | Pressure | after 1 h | after 5 h | Method |
| OB 1:2,2′-(1,2- | Triglycol | 260° C. | LP | >80% | >90% | HPLC |
| ethenediyldi-4,1- | | | | | | |
| phenylene)- | | | | | | |
| bisbenzoxazole | | | | | | |
| 4,4′-Bis(5- | Triglycol | 260° C. | LP | >30% | >85% | UV/VIS |
| Biscarboxymethyl-2- | | | | | | |
| benzoxazolyl)stilbene | | | | | | |
| Diethyl bis-3,3′-(1,2- | Triglycol | 260° C. | LP | >80% | >95% | UV/VIS |
| ethenediyldi-4,1- | | | | | | |
| phenylene)propenoate | | | | | | |
| 4-((3-methyl)oxadiazolyl- | Triglycol | 260° C. | LP | >95% | — | HPLC |
| 1,2,4)-4′-(benzoxazolyl)- | | | | | | |
| stilbene | | | | | | |
| 4,4′-Bis(2-methoxystyryl)- | Triglycol | 260° C. | LP | >60% | >80% | HPLC |
| 1,1′-biphenyl | | | | | | |
| 1,4-Bis(2-Cyanostyr- | Triglycol | 260° C. | LP | >70% | >90% | UV/VIS |
| beta-yl)benzene | | | | | | |

The values obtained clearly show that optical brighteners without an open-chain ethylenic double bond are more stable than optical brighteners which contain such a double bond.

1. A process for producing optically brightened polyester by esterifying an aliphatic and/or aromatic polycarboxylic acid and a polyol, where the esterification is carried out in the presence of an optical brightener whos structure is free from one or more open-chain ethylenic double bonds.

2. The process as claimed in claim 1, where the esterification is carried out in the presence of an optical brightener of the formulae 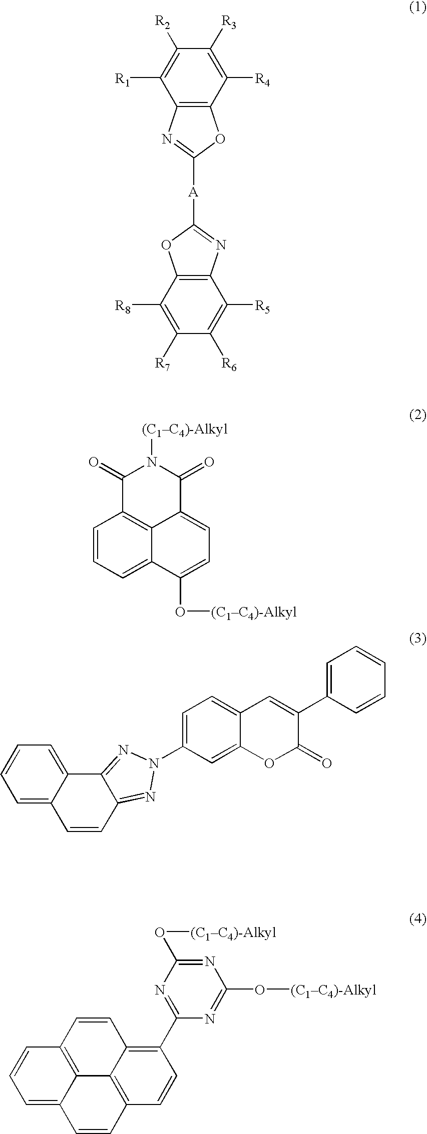
where
R₁ to R₈ independently of one another are hydrogen, C₁-C₂₀-alkyl or groups of the formula —COOR₉, where R₉ is hydrogen, C₁-C₂₀-alkyl or phenyl, or
R₁ to R₈ are a group of the formula —SO₂R₁₀, where R₁₀ is hydrogen, C₁-C₁₀-alkyl or C₁-C₁₀-hydroxyalkyl, and
A is naphthylene, phenylene, thiophenylene or biphenylene.

3. The process as claimed in claim 1, where optically brightened polyethylene glycol terephthalate is produced.

4. The process as claimed in claim 1, where aliphatic and/or aromatic polycarboxylic acid is a dicarboxylic acid.

5. The process as claimed in claim 1, where the polyol is a diol.

6. The process as claimed in claim 2, where optically brightened polyethylene glycol terephthalate is produced.

7. The process as claimed in claim 2, where the aliphatic and/or aromatic polycarboxylic acid is a dicarboxylic acid.

8. The process as claimed claim 2, where the polyol is a diol.

9. The process as claimed in claim 3, where the aliphatic and/or aromatic polycarboxylic acid is a dicarboxylic acid.

10. The process as claimed in claim 3, where the polyol is a diol.

11. The process as claimed in claim 4, where the polyol is a diol.
